(19) United States
(12) Patent Application Publication
(10) Pub. No.: US 2025/0203617 A1
(43) Pub. Date: Jun. 19, 2025

(54) SYSTEM AND METHOD FOR FRAME PROTECTION

(71) Applicant: NXP USA, Inc., AUSTIN, TX (US)

(72) Inventors: Liwen Chu, San Ramon, CA (US); Kiseon Ryu, San Diego, CA (US); Huizhao Wang, San Jose, CA (US); Ken Kinwah Ho, San Jose, CA (US); Hongyuan Zhang, Fremont, CA (US)

(21) Appl. No.: 18/975,406

(22) Filed: Dec. 10, 2024

Related U.S. Application Data
(60) Provisional application No. 63/611,301, filed on Dec. 18, 2023.

(51) Int. Cl. H04W 72/20; H04W 12/04

(52) U.S. Cl. CPC H04W 72/20; H04W 12/04

(57) ABSTRACT

Embodiments of a method and apparatus for communications are disclosed. In an embodiment, a wireless device includes a controller configured to generate a first protected control frame using an encryption key and a wireless transceiver configured to transmit the first protected control frame to a second wireless device.

### CROSS-REFERENCE TO RELATED APPLICATIONS

This application is entitled to the benefit of U.S. Provisional Patent Application Ser. No. 63/611,301, filed on Dec. 18, 2023, the contents of which are incorporated by reference herein.

### BACKGROUND

Wireless communications devices, e.g., access points (APs) or non-AP devices transmit various types of information using different transmission techniques. For example, various applications, such as, Internet of Things (IoT) applications conduct wireless local area network (WLAN) communications, for example, based on Institute of Electrical and Electronics Engineers (IEEE) 802.11 family of standards (e.g., Wi-Fi standards). In multi-link communications, an access point (AP) multi-link device (MLD) wirelessly transmit data to one or more wireless stations in a non-AP MLD through one or more wireless communications links. Some applications, for example, video teleconferencing, streaming entertainment, high definition (HD) video surveillance applications, outdoor video sharing applications, etc., require relatively high system throughput. To facilitate the proper data transmission within a wireless communications system, there is a need for wireless communications technology that efficiently and securely convey communications signaling information, for example, information related to data, communications links, and/or multi-link devices (e.g., operation and/or capability parameters of multi-link devices) within the wireless communications system.

### SUMMARY

Embodiments of a method and apparatus for wireless communications are disclosed. In an embodiment, a wireless device includes a controller configured to generate a first protected control frame using an encryption key and a wireless transceiver configured to transmit the first protected control frame to a second wireless device. Other embodiments are also disclosed.

In an embodiment, the controller is further configured to generate a second protected control frame using the encryption key, and the wireless transceiver is further configured to transmit the second protected control frame to the second wireless device.

In an embodiment, the first protected control frame includes a protected unicast control frame that is generated using the encryption key, and the second protected control frame includes a protected broadcast control frame that is generated using the encryption key.

In an embodiment, the encryption key includes a pair-wise key or a group key, and the first protected control frame is decrypted by the second wireless device.

In an embodiment, the pair-wise key includes a control frame peer transient key (CPTK).

In an embodiment, the group key includes a control frame group temporal key (CGTK).

In an embodiment, a trigger frame being the first or second protected control frame includes a protected trigger frame, and the protected trigger frame includes a trigger type value that indicates the protected trigger frame.

In an embodiment, packet number (PN) information and key identification (ID) information are carried right after a Media Access Control (MAC) header of the protected trigger frame.

In an embodiment, a multi-station (multi-STA) block acknowledgement (BA) frame being the first or second protected control frame includes a protected multi-STA BA frame, and the protected multi-STA BA frame includes a BA type value that indicates the protected multi-STA BA frame.

In an embodiment, packet number (PN) information and key identification (ID) information are carried right after a Media Access Control (MAC) header of the protected multi-STA BA frame.

In an embodiment, the first protected control frame includes a protected extended control frame, and the protected extended control frame includes an extended header that carries at least one extended control subtype field.

In an embodiment, the controller is further configured to generate a second protected control frame using a key for integrity checking, and the wireless transceiver is further configured to transmit the second protected control frame to the second wireless device.

In an embodiment, the first protected control frame includes a protected unicast control frame that is generated using the encryption key, and the second protected control frame includes a protected broadcast control frame that is generated using the key for integrity checking.

In an embodiment, the first protected control frame is decrypted by the second wireless device, and the second protected control frame is integrity checked by the second wireless device.

In an embodiment, a protected broadcast Trigger frame or multi-station (multi-STA) block acknowledgement (BA) frame is replaced by a protected unicast Trigger frame or Multi-STA BA frame, respectively, if the protected broadcast Trigger frame or multi-STA BA) frame is not for improving Transmit opportunity (TXOP) protection and not for a last frame of the TXOP.

In an embodiment, the wireless device includes a wireless multi-link device (MLD), and the second wireless device includes a second wireless MLD.

In an embodiment, the wireless device is compatible with an Institute of Electrical and Electronics Engineers (IEEE) 802.11 protocol.

In an embodiment, the wireless device includes a wireless access point (AP) or a non-AP station (STA).

In an embodiment, a wireless access point (AP) compatible with an Institute of Electrical and Electronics Engineers (IEEE) 802.11 protocol includes a controller configured to generate a first protected control frame using an encryption key and a wireless transceiver configured to transmit the first protected control frame to a second wireless device.

In an embodiment, a method for wireless communications includes at a first wireless device, generating a first protected control frame using an encryption key and from the first wireless device, transmitting the first protected control frame to a second wireless device.

Other aspects in accordance with the invention will become apparent from the following detailed description, taken in conjunction with the accompanying drawings, illustrated by way of example of the principles of the invention.

### BRIEF DESCRIPTION OF THE DRAWINGS

FIG. 1 depicts a wireless communications system in accordance with an embodiment of the invention.

FIG. 2 depicts a multi-link (ML) communications system that is used for wireless communications in accordance with an embodiment of the invention.

FIG. 3 depicts a wireless device in accordance with an embodiment of the invention.

FIG. 4 illustrates a protected trigger frame format in accordance with an embodiment of the invention.

FIG. 5 illustrates a special user information (Info) field format in accordance with an embodiment of the invention.

FIG. 6 illustrates a protected Multi-STA BA frame in accordance with an embodiment of the invention.

FIG. 7 illustrates an extended control frame format in accordance with an embodiment of the invention.

FIG. 8 illustrates an extended control frame in accordance with an embodiment of the invention.

FIG. 9 illustrates a unicast control frame in accordance with an embodiment of the invention.

FIG. 10 illustrates a unicast control frame in accordance with an embodiment of the invention.

FIG. 11 illustrates a protected trigger frame format in accordance with an embodiment of the invention.

FIG. 12 illustrates a protected Block Acknowledgement (BA) frame format in accordance with an embodiment of the invention.

FIG. 13 is a process flow diagram of a method for wireless communications in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

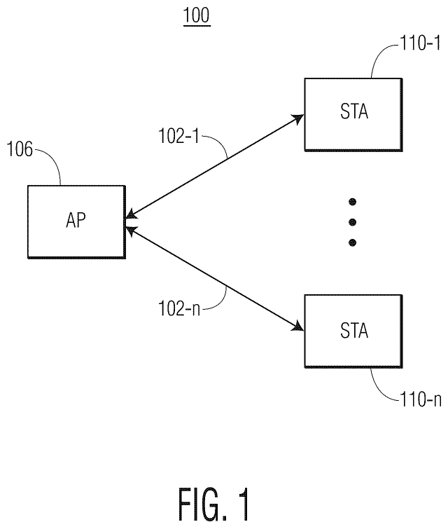

FIG. 1 depicts a wireless (e.g., WiFi) communications system 100 in accordance with an embodiment of the invention. In the embodiment depicted in FIG. 1, the wireless communications system 100 includes at least one AP 106 and at least one station (STA) 110-1, . . . , 110-n, where n is a positive integer. The wireless communications system can be used in various applications, such as industrial applications, medical applications, computer applications, and/or consumer or enterprise applications. In some embodiments, the wireless communications system is compatible with an IEEE 802.11 protocol. Although the depicted wireless communications system 100 is shown in FIG. 1 with certain components and described with certain functionality herein, other embodiments of the wireless communications system may include fewer or more components to implement the same, less, or more functionality. For example, in some embodiments, the wireless communications system includes multiple APs with multiple STAs, one AP with one STA, or one AP with multiple STAs. In another example, although the wireless communications system is shown in FIG. 1 as being connected in a certain topology, the network topology of the wireless communications system is not limited to the topology shown in FIG. 1. In some embodiments, the wireless communications system 100 described with reference to FIG. 1 involves single-link communications and the AP and the STA communicate through single communications link. In some embodiments, the AP 106 may be affiliated with an AP MLD, and a STA 100-j with j being an integer equal to one of 1 to n with n being an integer may be affiliated with a STA MLD j (=non-AP MLD j).

In the embodiment depicted in FIG. 1, the AP 106 may be implemented in hardware (e.g., circuits), software, firmware, or a combination thereof. The AP 106 may be fully or partially implemented as an integrated circuit (IC) device. In some embodiments, the AP 106 is a wireless AP compatible with at least one WLAN communications protocol (e.g., at least one IEEE 802.11 protocol). In some embodiments, the AP is a wireless AP that connects to a local area network (LAN) and/or to a backbone network (e.g., the Internet) through a wired connection and that wirelessly connects to one or more wireless stations (STAs), for example, through one or more WLAN communications protocols, such as the IEEE 802.11 protocol. In some embodiments, the AP includes at least one antenna, at least one transceiver operably connected to the at least one antenna, and at least one controller operably connected to the corresponding transceiver. In some embodiments, the transceiver includes a physical layer (PHY) device. The controller may be configured to control the transceiver to process received packets through the antenna. In some embodiments, the controller is implemented within a processor, such as a microcontroller, a host processor, a host, a digital signal processor (DSP), or a central processing unit (CPU), which can be integrated in a corresponding transceiver. In some embodiments, the AP 106 (e.g., a controller or a transceiver of the AP) implements upper layer Media Access Control (MAC) functionalities (e.g., association establishment, reordering of frames, etc.) and/or lower layer MAC functionalities (e.g., backoff, frame transmission, frame reception, etc.). Although the wireless communications system 100 is shown in FIG. 1 as including one AP, other embodiments of the wireless communications system 100 may include multiple APs. In these embodiments, each of the APs of the wireless communications system 100 may operate in a different frequency band. For example, one AP may operate in a 2.4 gigahertz (GHz) frequency band and another AP may operate in a 5 GHz frequency band.

In the embodiment depicted in FIG. 1, each of the at least one STA 110-1, . . . , 110-n may be implemented in hardware (e.g., circuits), software, firmware, or a combination thereof. The STA 110-1, . . . , or 110-n may be fully or partially implemented as IC devices. In some embodiments, the STA 110-1, . . . , or 110-n is a communication device compatible with at least one IEEE 802.11 protocol. In some embodiments, the STA 110-1, . . . , or 110-n is implemented in a laptop, a desktop personal computer (PC), a mobile phone, or other communications device that supports at least one WLAN communications protocol. In some embodiments, the STA 110-1, . . . , or 110-n implements a common MAC data service interface and a lower layer MAC data service interface. In some embodiments, the STA 110-1, . . . , or 110-n includes at least one antenna, at least one transceiver operably connected to the at least one antenna, and at least one controller connected to the corresponding transceiver. In some embodiments, the transceiver includes a PHY device. The controller may be configured to control the transceiver to process received packets through the antenna. In some embodiments, the controller is implemented within a processor, such as a microcontroller, a host processor, a host, a DSP, or a CPU, which can be integrated in a corresponding transceiver.

In the embodiment depicted in FIG. 1, the AP 106 communicates with the at least one STA 110-1, . . . , 110-n via a communication link 102-1, . . . , 102-n, where n is a positive integer. In some embodiments, data communicated between the AP and the at least one STA 110-1, . . . , 110-n includes MAC protocol data units (MPDUs). An MPDU may include a frame header, a frame body, and a trailer with the MPDU payload encapsulated in the frame body.

In some embodiments of a wireless communications system, a wireless device, e.g., an access point (AP) multi-link device (MLD) of a wireless local area network (WLAN) may transmit data to at least one associated station (STA) MLD. The AP MLD may be configured to operate with associated STA MLDs according to a communication protocol. For example, the communication protocol may be an Ultra High Reliability (UHR) communication protocol, or Institute of Electrical and Electronics Engineers (IEEE) 802.11bn communication protocol. In some embodiments of the wireless communications system described herein, different associated STAs within range of an AP operating according to the UHR communication protocol are configured to operate according to at least one other communication protocol, which defines operation in a Basic Service Set (BSS) with the AP, but are generally affiliated with lower reliable protocols. The lower reliable communication protocols (e.g., Extremely High Throughput (EHT) communication protocol that is compatible with IEEE 802.11be standards, High Efficiency (HE) communication protocol that is compatible with IEEE 802.11ax standards, Very High Throughput (VHT) communication protocol that is compatible with IEEE 802.11ac standards, etc.) may be collectively referred to herein as “legacy” communication protocols.

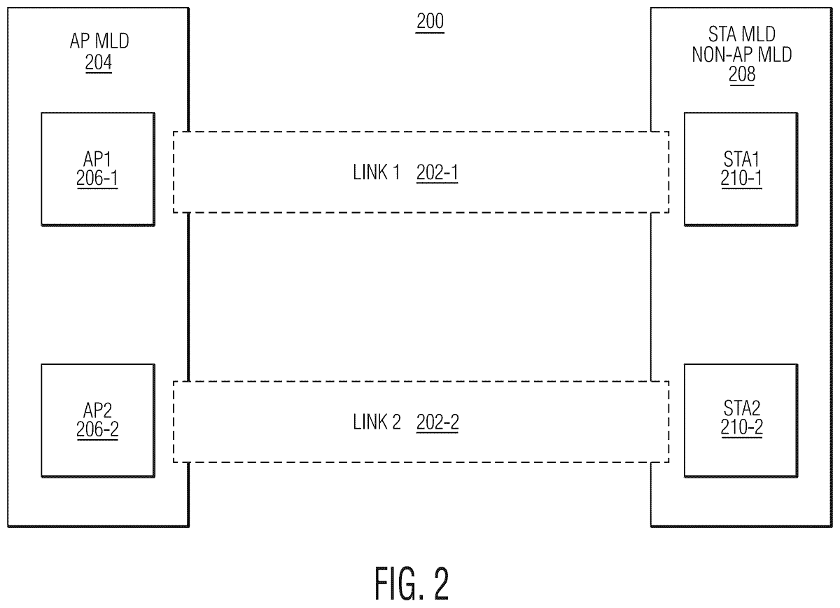

FIG. 2 depicts a multi-link (ML) communications system 200 that is used for wireless (e.g., WiFi) communications in accordance with an embodiment of the invention. In the embodiment depicted in FIG. 2, the multi-link communications system includes one AP multi-link device, which is implemented as AP MLD 204, and one non-AP STA multi-link device, which is implemented as STA MLD (non-AP MLD) 208. The multi-link communications system can be used in various applications, such as industrial applications, medical applications, computer applications, and/or consumer or enterprise applications. In some embodiments, the multi-link communications system may be a wireless communications system, such as a wireless communications system compatible with an IEEE 802.11 protocol. For example, the multi-link communications system may be a wireless communications system compatible with an IEEE 802.11bn protocol. Although the depicted multi-link communications system 200 is shown in FIG. 2 with certain components and described with certain functionality herein, other embodiments of the multi-link communications system may include fewer or more components to implement the same, less, or more functionality. For example, in some embodiments, the multi-link communications system includes a single AP MLD with multiple STA MLDs, or multiple AP MLDs with more than one STA MLD. In some embodiments, the legacy STAs (non-UHR STAs) may associate with one of the APs affiliated with the AP MLD. In another example, although the multi-link communications system is shown in FIG. 2 as being connected in a certain topology, the network topology of the multi-link communications system is not limited to the topology shown in FIG. 2.

In the embodiment depicted in FIG. 2, the AP MLD 204 includes two APs in two links, implemented as APs 206-1 and 206-2. In such an embodiment, the APs may be AP1 206-1 and AP2 206-2. In some embodiments, a common part of the AP MLD 204 implements upper layer Media Access Control (MAC) functionalities (e.g., association establishment, reordering of frames, etc.) and a link specific part of the AP MLD 204, i.e., the APs 206-1 and 206-2, implement lower layer MAC functionalities (e.g., backoff, frame transmission, frame reception, etc.). The APs 206-1 and 206-2 may be implemented in hardware (e.g., circuits), software, firmware, or a combination thereof. The APs 206-1 and 206-2 may be fully or partially implemented as an integrated circuit (IC) device. In some embodiments, the APs 206-1 and 206-2 may be wireless APs compatible with at least one WLAN communications protocol (e.g., at least one IEEE 802.11 protocol). For example, the APs 206-1 and 206-2 may be wireless APs compatible with an IEEE 802.11bn protocol. In some embodiments, an AP MLD (e.g., AP MLD 204) connects to a local network (e.g., a LAN) and/or to a backbone network (e.g., the Internet) through a wired connection and wirelessly connects to wireless STAs, for example, through one or more WLAN communications protocols, such as an IEEE 802.11 protocol. In some embodiments, an AP (e.g., AP1 206-1 and/or AP2 106-2) includes at least one antenna, at least one transceiver operably connected to the at least one antenna, and at least one controller operably connected to the corresponding transceiver. In some embodiments, at least one transceiver includes a physical layer (PHY) device. The at least one controller may be configured to control the at least one transceiver to process received packets through the at least one antenna. In some embodiments, the at least one controller may be implemented within a processor, such as a microcontroller, a host processor, a host, a digital signal processor (DSP), or a central processing unit (CPU), which can be integrated in a corresponding transceiver. In some embodiments, each of the APs 206-1 or 206-2 of the AP MLD 204 may operate in a different BSS operating channel. For example, AP1 206-1 may operate in a 320 MHz (one million hertz) BSS operating channel at 6 Gigahertz (GHz) band and AP2 206-2 may operate in a 160 MHz BSS operating channel at 5 GHz band. Although the AP MLD 204 is shown in FIG. 2 as including two APs, other embodiments of the AP MLD 204 may include more than two APs or only one AP.

In the embodiment depicted in FIG. 2, the non-AP STA multi-link device, implemented as STA MLD 208, includes STAs non-AP STAs 210-1 and 210-2 on two links. In such an embodiment, the non-AP STAs may be STA1 210-1 and STA2 210-2. The STAs 210-1 and 210-2 may be implemented in hardware (e.g., circuits), software, firmware, or a combination thereof. The STAs 210-1 and 210-2 may be fully or partially implemented as an IC device. In some embodiments, the non-AP STAs 210-1 and 210-2 are part of the STA MLD 208, such that the STA MLD may be a communications device that wirelessly connects to a wireless AP MLD. For example, the STA MLD 208 may be implemented in a laptop, a desktop personal computer (PC), a mobile phone, or other communications device that supports at least one WLAN communications protocol. In some embodiments, the non-AP STA MLD 208 is a communications device compatible with at least one IEEE 802.11 protocol (e.g., an IEEE 802.11 bn protocol, an 802.11be protocol, an IEEE 802.11ax protocol, or an IEEE 802.11ac protocol). In some embodiments, the STA MLD 208 implements a common MAC data service interface and the non-AP STAs 210-1 and 210-2 implement a lower layer MAC data service interface.

In some embodiments, the AP MLD 204 and/or the STA MLD 208 may identify which communication links support multi-link operation during a multi-link operation setup phase and/or exchanges information regarding multi-link capabilities during the multi-link operation setup phase. In some embodiments, each of the non-AP STAs 210-1 and 210-2 of the STA MLD 208 may operate in a different frequency band. For example, the non-AP STA 210-1 may operate in the 2.4 GHz frequency band and the non-AP STA 210-2 may operate in the 5 GHz frequency band. In some embodiments, each STA includes at least one antenna, at least one transceiver operably connected to the at least one antenna, and at least one controller connected to the corresponding transceiver. In some embodiments, at least one transceiver includes a PHY device. The at least one controller may be configured to control the at least one transceiver to process received packets through the at least one antenna. In some embodiments, the at least one controller may be implemented within a processor, such as a microcontroller, a host processor, a host, a DSP, or a CPU, which can be integrated in a corresponding transceiver.

In the embodiment depicted in FIG. 2, the STA MLD 208 communicates with the AP MLD 204 via two communication links, e.g., link 1 202-1 and link 2 202-2. For example, each of the non-AP STAs 210-1 or 210-2 communicates with an AP 206-1 or 206-2 via corresponding communication links 202-1 or 202-2. In an embodiment, a communication link (e.g., link 1 202-1 or link 2 202-2) may include a BSS operating channel established by an AP (e.g., AP1 206-1 or AP2 206-2) that features multiple 20 MHz channels used to transmit frames (e.g., beacon frames, management frames other than Beacon, Data frames, control frames etc. in Physical Layer Protocol Data Units (PPDUs)) between a first wireless device (e.g., an AP, an AP MLD, an STA, or an STA MLD) and a second wireless device (e.g., an AP, an AP MLD, an STA, or an STA MLD). In some embodiments, a 20 MHz channel covered by the BSS operating channel may be a punctured 20 MHz channel or an unpunctured 20 MHz channel. Although the STA MLD 208 is shown in FIG. 2 as including two non-AP STAs, other embodiments of the STA MLD 208 may include one non-AP STA or more than two non-AP STAs. In addition, although the AP MLD 204 communicates (e.g., wirelessly communicates) with the STA MLD 208 via the communications links 202-1 and 202-2, in other embodiments, the AP MLD 204 may communicate (e.g., wirelessly communicate) with the STA MLD 208 via more than two communication links or less than two communication links.

In some embodiments, a first MLD, e.g., an AP MLD or non-AP MLD (STA MLD), may transmit MLD-level management frames in a multi-link operation with a second MLD, e.g., STA MLD or AP MLD, to coordinate the multi-link operation between the first MLD and the second MLD. As an example, a management frame may be a channel switch announcement frame, a (Re)Association Request frame, a (Re)Association Response frame, a Disassociation frame, an Authentication frame, and/or a Block Acknowledgement (Ack) (BA) Action frame, etc. In some embodiments, an AP/STA of a first MLD may transmit link-level management frames to a STA/AP of a second MLD. In some embodiments, one or more link-level management frames may be transmitted via a cross-link transmission (e.g., according to an IEEE 802.11bn communication protocol). As an example, a cross-link management frame transmission may involve a management frame being transmitted and/or received on one link (e.g., link 1 202-1) while carrying information of another link (e.g., link 2 202-2). In some embodiments, a management frame is transmitted on any link (e.g., at least one of two links or at least one of multiple links) between a first MLD (e.g., AP MLD 204) and a second MLD (e.g., STA MLD 208). As an example, a management frame may be transmitted between a first MLD and a second MLD on any link (e.g., at least one of two links or at least one of multiple links) associated with the first MLD and the second MLD.

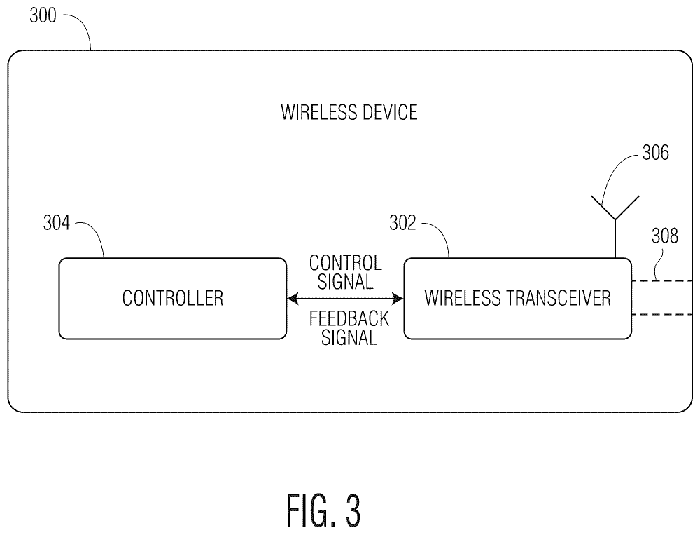

FIG. 3 depicts a wireless device 300 in accordance with an embodiment of the invention. The wireless device 300 can be used in the wireless communications system 100 depicted in FIG. 1 and/or the multi-link communications system 200 depicted in FIG. 2 for each link independently. For example, the wireless device 300 may be an embodiment of the AP 106 depicted in FIG. 1, the STA 110-1, . . . , 110-n depicted in FIG. 1, the APs 206-1, 206-2 depicted in FIG. 2, and/or the STAs 210-1, 210-2 depicted in FIG. 2. In the embodiment depicted in FIG. 3, the wireless device 300 includes a wireless transceiver 302, a controller 304 operably connected to the wireless transceiver, and at least one antenna 306 operably connected to the wireless transceiver. In some embodiments, the wireless device 300 may include at least one optional network port 308 operably connected to the wireless transceiver. In some embodiments, the wireless transceiver includes a physical layer (PHY) device. The wireless transceiver may be any suitable type of wireless transceiver. For example, the wireless transceiver may be a LAN transceiver (e.g., a transceiver compatible with an IEEE 802.11 protocol). In some embodiments, the wireless device 300 includes multiple transceivers. The controller may be configured to control the wireless transceiver (e.g., by generating a control signal) to process packets received through the antenna and/or the network port and/or to generate outgoing packets to be transmitted through the antenna and/or the network port. In some embodiments, the wireless transceiver transmits one or more feedback signals to the controller. In some embodiments, the controller is implemented within a processor, such as a microcontroller, a host processor, a host, a DSP, or a CPU. In some embodiments, the wireless transceiver 302 is implemented in hardware (e.g., circuits), software, firmware, or a combination thereof. The antenna may be any suitable type of antenna. For example, the antenna may be an induction type antenna such as a loop antenna or any other suitable type of induction type antenna. However, the antenna is not limited to an induction type antenna. The network port may be any suitable type of port.

In accordance with an embodiment of the invention, the controller 304 is configured to generate a first protected control frame using an encryption key, and the wireless transceiver 302 is configured to transmit the first protected control frame to a second wireless device, for example, through the at least one antenna 306. In some embodiments, the controller 304 is further configured to generate a second protected control frame using the encryption key, and the wireless transceiver 302 is further configured to transmit the second protected control frame to the second wireless device. In some embodiments, the first protected control frame includes a protected unicast (i.e., individual-addressed) control frame that is generated using the encryption key, and the second protected control frame includes a protected broadcast control frame that is generated using the encryption key. In some embodiments, the encryption key includes a pair-wise key or a group key, and the first protected control frame is decrypted by the second wireless device. In some embodiments, the pair-wise key includes a control frame peer transient key (CPTK). In some embodiments, the group key includes a control frame group temporal key (CGTK). In some embodiments, a trigger frame being the first or second protected control frame includes a protected trigger frame, and the protected trigger frame includes a trigger type value that indicates the protected trigger frame. In some embodiments, packet number (PN) information and key identification (ID) information are carried right after a Media Access Control (MAC) header of the protected trigger frame. In some embodiments, a multi-station (multi-STA) block acknowledgement (BA) frame being the first or second protected control frame includes a protected multi-station (multi-STA) block acknowledgement (BA) frame, and the protected multi-STA BA frame includes a BA type value that indicates the protected multi-STA BA frame. In some embodiments, the Key ID and PN are carried right after a Media Access Control (MAC) header of the protected multi-STA BA frame. In some embodiments, the first protected control frame includes a protected extended control frame, and the protected extended control frame includes an extended header that carries at least one extended control subtype field. In some embodiments, the encryption key includes a pair-wise key or a group key, and the first protected control frame is decrypted by the second wireless device. In some embodiments, the pair-wise key includes a control frame peer transient key (CPTK). In some embodiments, the pair-wise key shares a transient key (TK) with unicast data/management frame protection with a PN space being divided to two sub PN spaces where one sub PN space is for Data+Management frames and another sub PN space is for protected control frames. In some embodiments, the group key includes a control frame group temporal key (CGTK). In some embodiments, the controller 304 is further configured to generate a second protected control frame using a key for integrity checking, and the wireless transceiver 302 is further configured to transmit the second protected control frame with integrity protection to the second wireless device. In some embodiments, the first protected control frame includes a protected unicast control frame that is generated using the encryption key, and the second protected control frame includes a protected broadcast control frame that is generated using the key for integrity checking. In some embodiments, the first protected control frame is decrypted by the second wireless device, and the second protected control frame is integrity checked by the second wireless device. In some embodiments, a protected broadcast Trigger frame or multi-station (multi-STA) block acknowledgement (BA) frame is replaced by a protected unicast Trigger frame or Multi-STA BA frame, respectively, if the protected broadcast Trigger frame or multi-STA BA) frame is not for better Transmit opportunity (TXOP) protection and not for a last frame of the TXOP. In some embodiments, packet number (PN) information and key identification (ID) information are carried in the first protected control frame and the second protected control frame. In some embodiments, the wireless device 300 includes a wireless access point (AP) or a wireless non-AP station (STA). In some embodiments, the wireless device 300 is compatible with an Institute of Electrical and Electronics Engineers (IEEE) 802.11 protocol. In some embodiments, the wireless device includes a wireless multi-link device (MLD), the second wireless device includes a second wireless MLD, and the wireless transceiver 302 is further configured to conduct frame exchanges with the second wireless MLD through a wireless link between the wireless MLD and the second wireless MLD.

In some cases, a unicast control frame and a broadcast control frame are protected through encryption, decryption. In some cases, a unicast control frame is protected through encryption, decryption, and a broadcast control frame is protected through integrity protection. In some cases, a unicast control frame and broadcast control frame are protected through integrity protection. It is assumed that the following frames are protected, including broadcast/unicast Trigger frames, broadcast/unicast Multi-STA Block acknowledgement (BA) frames, uncast Compressed Block Ack Request (BAR) frames, unicast Multi-TID (Traffic Identifier) BAR frames. The protected multi-STA BA frame is used when the responding frame is a compressed BA or Ack frame. One variant is that a unicast Compressed BA frame is protected. The other unicast control frames, broadcast control frames can be processed similarly if required.

Some implementations of various protection combinations of broadcast and unicast control frame, for example, by the wireless communications system 100 depicted in FIG. 1, the multi-link (ML) communications system 200 depicted in FIG. 2, and/or the wireless device 300 depicted in FIG. 3 are described as follows.

In some embodiments, in Combination 1, the broadcast and unicast control frames that need to be protected are all encrypted/decrypted by CPTK, CGTK and related PN.

In some embodiments, in Combination 2, the unicast control frames that need to be protected are all encrypted/decrypted by CPTK and related PN. The broadcast control frames that need to be protected have integrity protection by CPTK and related PN.

In some embodiments, in Combination 3, the broadcast and unicast control frames that need to be protected have integrity protection by CPTK, CGTK and related PN.

Some implementations of Control Frame Protection Combination 1 are described as follows.

In some embodiments, when a broadcast Control frame with fields addressed to different STAs that are identified by STAs' Association IDs (AIDS) (e.g., AID12 subfield of User Info field in a Trigger frame, AID11 subfield of Per AID TID Info subfield in a Multi-STA BA frame), the encryption can change the content of the subfield that identifies the addressed STA.

In some embodiments, the updated protected Trigger frame needs to let the STAs that do not support control protection to assume that the frame is not Trigger frame or is a Trigger frame with Trigger Type that they do not understand. In some embodiments, a protected Trigger frame cannot have the User Info field being addressed to a STA that does not support control frame protection.

In some embodiments, the updated protected Multi-STA BA frame needs to let the STAs that do not support control protection to assume that the frame is not Multi-STA frame. In some embodiments, a protected Multi-STA BA frame cannot have the Per AID TID Info field being addressed to a STA that does not support control frame protection.

In some embodiments, the variants of protection indication and key ID are described as follows.

In some embodiments, the Key ID is carried in a Frame Control field, and the protection indication is not carried in the Frame Control field where the recipient checks the transmitter's capability to decide whether the control frame is protected or not. In some embodiments, the PN is carried after MAC header and before the fields for various STAs.

In some embodiments, the protection indication and Key ID are carried in a Frame Control field. In some embodiments, the PN is carried after the MAC header and before the fields for the addressed STA or the various addressed STAs.

In some embodiments, key ID, and PN are carried after the MAC header and before the fields for the addressed STA or the various addressed STAs, and the protection indication is not carried in the control field where the recipient check the transmitter's capability to decide whether the control frame is protected or not.

In some embodiments, the protection indication, key ID, and PN are carried after the MAC header and before the fields for the addressed STA or the various addressed STAs.

Some implementations of Control Frame Protection Combination 1—Trigger and Multi-STA BA frames are described as follows.

Solution 1 for Trigger frame:

In some embodiments, a new Trigger Type value “PROTECTED TRIGGER” is defined and carried in Trigger Type field and B0 to B3 of Protected Header field. Because the STAs that do not support control frame protection cannot understand the “Protected Trigger” Trigger Type value, these STAs will skip the frame. Such STAs may assume that the Protection Header to be Common Info field with Trigger Type that they do not understand.

In some embodiments, the “Encapsulated Trigger Subtype” and PN, Key ID are carried in the Protection Header field (8-octet field or the other length field). In some embodiments, the Protection Header field is carried after TA field.

In some embodiments, the new Encapsulated Trigger Subtype in Special User Info field indicated the protected Trigger type (e.g. protected Basic Trigger etc.).

In some embodiments, the frame body with the Common Info and User Info List are protected with MIC are carried in the last group of special User Info fields right before Padding.

### A Variant of Solution 1 for Trigger Frame

In some embodiments, the Encapsulated Trigger Subtype (e.g., indicating Basic Trigger, multi-user (MU)-RTS (Request to Send) being protected) and PN, Key ID are carried in the Protection Header field (8-octet field or the other length field). In some embodiments, the Protection Header field is carried after a TA field.

In some embodiments, the frame body with the User Info List are protected with MIC are carried in the last group of special User Info fields tight before Padding.

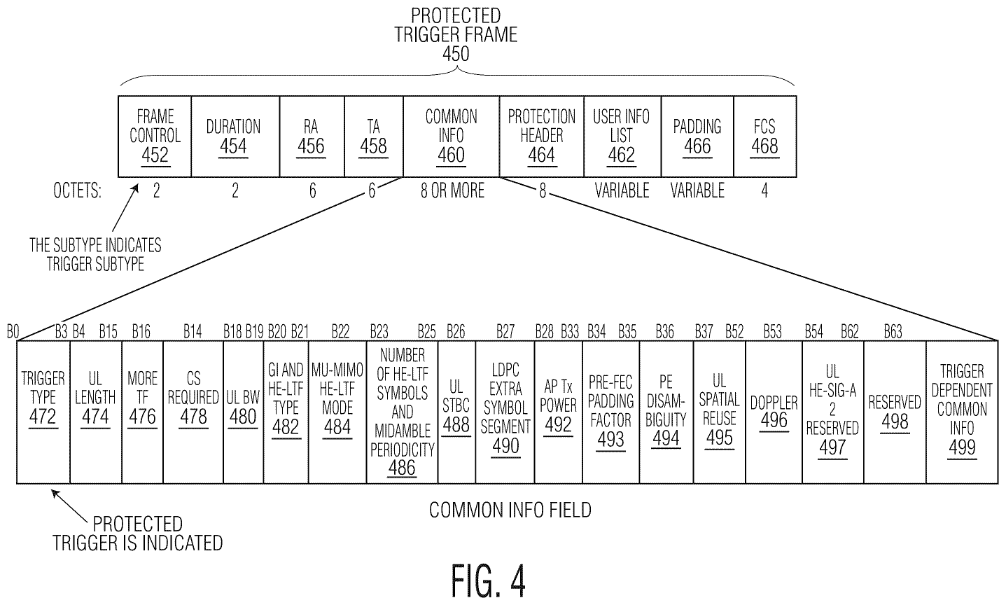

FIG. 4 illustrates a protected trigger frame format 450 in accordance with an embodiment of the invention. The protected trigger frame format 450 illustrated in FIG. 4 may be used by the wireless communications system 100 depicted in FIG. 1, the multi-link (ML) communications system 200 depicted in FIG. 2, and/or the wireless device 300 depicted in FIG. 3. In the embodiment depicted in FIG. 4, the protected trigger frame format 450 includes a frame control field 452 (e.g., two-octet) that may contain frame control information (e.g., the SubType indicates Trigger subtype), a frame duration field 454 (e.g., two-octet) that may contain frame duration information, a RA (receiver address or broadcast address) field 456 (e.g., six-octet) that may contain receiver address information, a TA (transmitter address) field 458 (e.g., six-octet) that may contain transmitter address information, a common information (info) field 460 (e.g., eight-octet or more) that may contain common information, a user information list field 462 (e.g., variable length) that may contain user information list (e.g., the first User Info field being the Special User Info field to carry PHY version, additional bandwidth (BW) information of the solicited trigger based (TB) PPDU etc.), a protection header 464 (e.g., eight-octet) that may contain protection header information, a padding field 466 (e.g., variable length) that may contain padding information, and a frame check sequence (FCS) field 468 (e.g., four-octet) that may contain FCS information. In some embodiments, the frame control field 452, the frame duration field 454, the RA field 456, and the TA field 458 form a MAC header. In some embodiments, the common info field 460 includes a trigger type subfield 472 (e.g., four-bit) that may contain trigger type information (e.g., information indicated a protected trigger frame), an uplink (UL) length subfield 474 (e.g., twelve-bit) that may contain UL length information, a More TF (trigger frame) subfield 476 (e.g., one-bit) that may contain trigger frame information, a CS (Carrier Sense) required subfield 478 (e.g., one-bit) that may contain carrier sense information, an uplink (UL) BW subfield 480 (e.g., two-bit) that may contain UL BW information, a guard interval (GI) and High Efficiency (HE)-Long Training field (LTF) type subfield 482 (e.g., two-bit) that may contain GI and HE-LTF information, a Multi-User, Multiple Input, Multiple Output (MU-MIMO) HE-LTF mode subfield 484 (e.g., one-bit) that may contain MU-MIMO HE-LTF information, a Number of HE-LTF symbols and Mid-amble Periodicity subfield 486 (e.g., three-bit) that may contain information regarding the number of HE-LTF symbols and Mid-amble Periodicity, an UL Space-time block code (STBC) subfield 488 (e.g., one-bit) that may contain UL STBC information, a Low Density Parity Check (LDPC) Extra Symbol Segment subfield 490 (e.g., one-bit) that may contain LDPC extra symbol segment information, an AP transmitter (Tx) power subfield 492 (e.g., six-bit) that may contain LAP Tx power information, a Pre-FEC (Forward Error Correction) Padding factor subfield 493 (e.g., two-bit) that may contain Pre-FEC padding factor information, a Packet Extension (PE) Disambiguity subfield 494 (e.g., one-bit) that may contain PE Disambiguity information, a UL Spatial Reuse subfield 495 (e.g., sixteen-bit) that may contain UL spatial reuse information, a Doppler subfield 496 (e.g., one-bit) that may contain doppler information, an UL HE_SIG_A2 (SIG refers to Signal) Reserved subfield 497 (e.g., nine-bit) that may contain UL HE_SIG_A2 reserved information, a reserved subfield 498 (e.g., one-bit) that may contain reserved information, and a trigger dependent common Info subfield 499 that may contain trigger dependent common information.

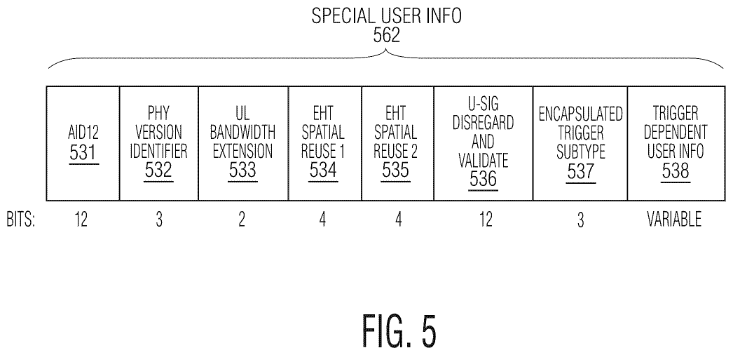

FIG. 5 illustrates a special user information (Info) field format 562 in accordance with an embodiment of the invention. The special user Info field format 562 illustrated in FIG. 5 may be used by the wireless communications system 100 depicted in FIG. 1, the multi-link (ML) communications system 200 depicted in FIG. 2, and/or the wireless device 300 depicted in FIG. 3. The special user Info field format 562 depicted in FIG. 5 may be an embodiment of one of user info fields included in the user information list field 462 illustrated in FIG. 4. In the embodiment depicted in FIG. 5, the special user Info field format 562 includes an Association ID (AID) AID12 subfield 531 (e.g., twelve-bit) that may contain AID information, a physical layer (PHY) version Identifier subfield 532 (e.g., three-bit) that may contain PHY version Identifier information, a UL Bandwidth

Extension subfield 533 (e.g., two-bit) that may contain UL Bandwidth Extension information, an EHT Spatial Reuse 1 subfield 534 (e.g., four-bit) that may contain EHT Spatial Reuse information, an EHT Spatial Reuse 2 subfield 535 (e.g., four-bit) that may contain EHT Spatial Reuse information, an U-SIG Disregard And Validate subfield 536 (e.g., twelve-bit) that may contain U-SIG disregard and validate information, an Encapsulated Trigger Subtype subfield 537 (e.g., three-bit) that may contain encapsulated trigger type information (e.g., an indication of a protected Basic Trigger frame, a protected MU-RTS frame, or a protected BSRP Trigger frame), and a trigger dependent user info subfield 538 (e.g., variable) that may contain trigger dependent user information.

Solution 1 for Multi-STA BA frame:

In some embodiments, a new BA Type value “Protected Multi-STA BA” is defined. Because the STAs that do not support control frame protection cannot understand the “Protected Multi-STA BA” value, they will skip the frame.

In some embodiments, the PN, Key ID are carried in the Protection Header field (8-octet field or the other length field)

In some embodiments, the Message Integrity Check (MIC) information is carried in Per AID TID Info fields of BA Information field right before FCS and before the Padding if exists in a protected Multi-STA BA frame.

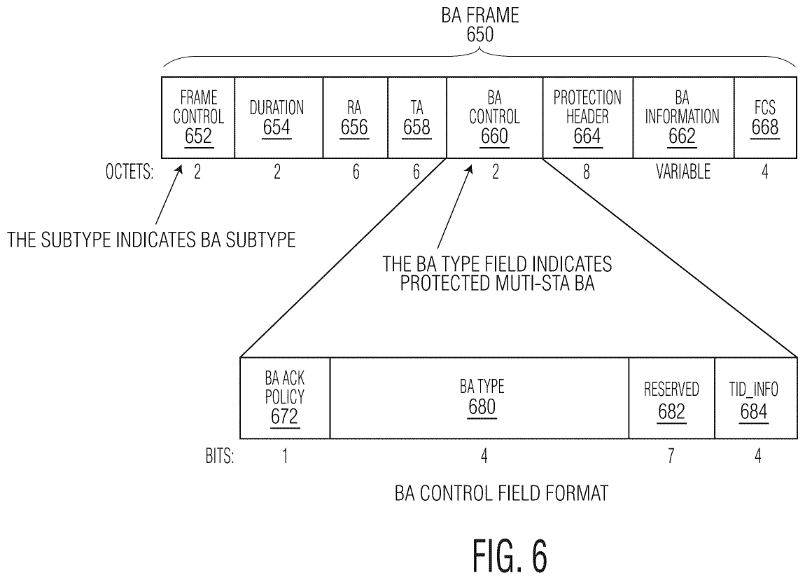

FIG. 6 illustrates a protected Multi-STA BA frame 650 in accordance with an embodiment of the invention. The protected Multi-STA BA frame 650 illustrated in FIG. 6 may be used by the wireless communications system 100 depicted in FIG. 1, the multi-link (ML) communications system 200 depicted in FIG. 2, and/or the wireless device 300 depicted in FIG. 3. In the embodiment depicted in FIG. 6, the protected Multi-STA BA frame 650 includes a frame control field 652 (e.g., two-octet) that may contain frame control information, a frame duration field 654 (e.g., two-octet) that may contain frame duration information, a RA (receiver address or broadcast address) field 656 (e.g., six-octet) that may contain receiver address information, a TA (transmitter address) field 658 (e.g., six-octet) that may contain transmitter address information, a BA control field 660 (e.g., two-octet) that may contain BA control information (e.g., the BA Type field indicates a Protected Multi-STA BA frame, an unprotected Multi-STA BA frame, or an unprotected Compressed BA frame), a protection header 664 (e.g., eight-octet) that may contain protection header information if the BA control field 660 indicates a Protected Multi-STA BA frame, a BA information field 662 (e.g., variable length) that may contain BA information, and a frame check sequence (FCS) field 668 (e.g., four-octet) that may contain FCS information. In some embodiments, the frame control field 652, the frame duration field 654, the RA field 656, and the TA field 658 form a MAC header. In some embodiments, the BA control field 660 includes a BA Ack Policy subfield 672 (e.g., one-bit) that may contain BA Ack policy information, a BA type subfield 680 (e.g., four-bit) that may contain BA type information (e.g., information indicated a protected Multi-STA BA frame), a reserved subfield 682 (e.g., seven-bit) that may contain reserved information, and a TID_Info subfield 684 (e.g., four-bit) that may contain TID information.

### Solution 2

In some embodiments, a new Control frame type “Extended Control frame” is defined.

In some embodiments, the Extended Header with variable length carries at least one Extended Control Subtype field, and one bit to indicate whether the control frame is protected. The Extended Header may carry the control frame protection information (Key ID, PN) if the bit indicates that the control frame is protected.

In some embodiments, in another variant, the Extended Header with fixed length carries at least one Extended Control Subtype field, and one bit to indicate whether the control frame is protected. In some embodiments, if the bit in Extended Header field indicates that the control frame is protected, the Protection Header field with Key ID and PN immediately follows Extend Header field.

In some embodiments, the frame body with the Common Info and User Info List are protected with MIC are carried in the last group of special User Info fields tight before Padding.

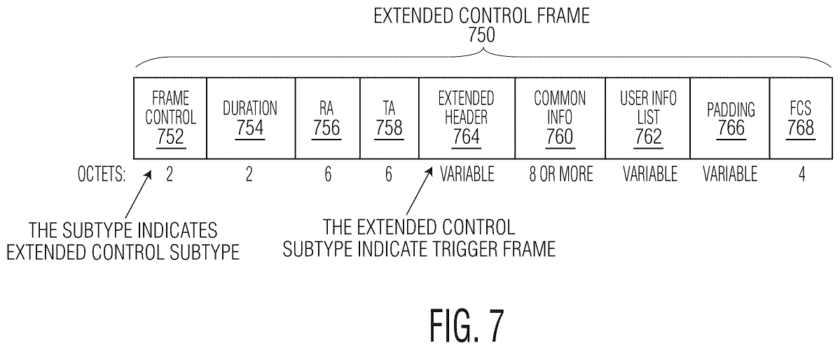

FIG. 7 illustrates an extended control frame format 750 in accordance with an embodiment of the invention. The extended control frame format 750 illustrated in FIG. 7 may be used by the wireless communications system 100 depicted in FIG. 1, the multi-link (ML) communications system 200 depicted in FIG. 2, and/or the wireless device 300 depicted in FIG. 3. In the embodiment depicted in FIG. 7, the extended control frame format 750 includes a frame control field 752 (e.g., two-octet) that may contain frame control information (e.g., the SubType indicates extended control subtype), a frame duration field 754 (e.g., two-octet) that may contain frame duration information, a RA (receiver address or broadcast address) field 756 (e.g., six-octet) that may contain receiver address information, a TA (transmitter address) field 758 (e.g., six-octet) that may contain transmitter address information, an extended header field 764 (e.g., variable length) that may contain extended header information (e.g., the Extended Control Subtype indicates a protected Trigger frame), a common information (info) field 760 (e.g., eight-octet or more) that may contain common information, a user information list field 762 (e.g., variable length) that may contain user information list (e.g., the first User Info field being the Special User Info field to carry PHY version, additional BW information of the solicited TB PPDU etc.), a padding field 766 (e.g., variable length) that may contain padding information, and a frame check sequence (FCS) field 768 (e.g., four-octet) that may contain FCS information. In some embodiments, the frame control field 752, the frame duration field 754, the RA field 756, and the TA field 758 form a MAC header.

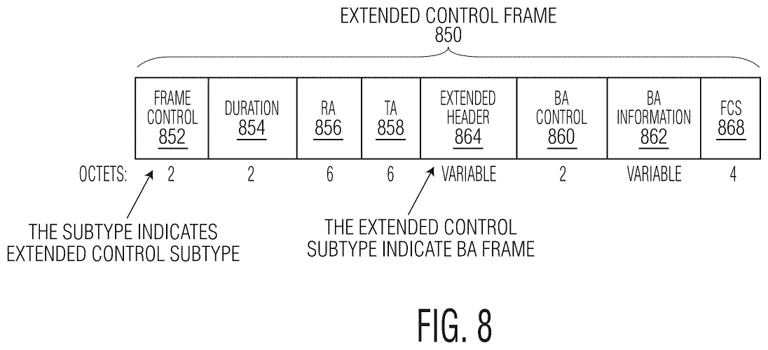

FIG. 8 illustrates an extended control frame 850 in accordance with an embodiment of the invention. The extended control frame 850 illustrated in FIG. 8 may be used by the wireless communications system 100 depicted in FIG. 1, the multi-link (ML) communications system 200 depicted in FIG. 2, and/or the wireless device 300 depicted in FIG. 3. In the embodiment depicted in FIG. 8, the extended control frame 850 includes a frame control field 852 (e.g., two-octet) that may contain frame control information (e.g., the SubType indicates extended control subtype), a frame duration field 854 (e.g., two-octet) that may contain frame duration information, a RA (receiver address or broadcast address) field 856 (e.g., six-octet) that may contain receiver address information, a TA (transmitter address) field 858 (e.g., six-octet) that may contain transmitter address information, an extended header field 864 (e.g., variable length) that may contain extended header information (e.g., the Extended Control Subtype indicates a protected Multi-STA BA frame), a BA control field 860 (e.g., two-octet) that may contain BA control information, a BA information field 862 (e.g., variable length) that may contain BA information, and a frame check sequence (FCS) field 868 (e.g., four-octet) that may contain FCS information. In some embodiments, the frame control field 852, the frame duration field 854, the RA field 856, and the TA field 858 form a MAC header.

### Unicast Control Frame

In some embodiments, the unicast control frame is the unicast control frame (one of BAR, uncast Trigger, unicast Multi-STA BA) other than a broadcast Trigger frame, and a broadcast Multi-STA BA frame. In some embodiments, the uncast Trigger frame and the unicast Multi-STA BA frame are processed in the same way as a broadcast Trigger frame and a broadcast Multi-STA BA frame.

Solution 1 for unicast frames whose control subtype does not have broadcast control frame usage:

The protection of the unicast control frame may be explicitly indicated or implicitly indicated.

In some embodiments, the Protection Header field with Key ID and PN immediately follows MAC Header field. In some embodiments, The frame body carries the frame body of the protected unicast control frame. In some embodiments, the MIC is located before FCS. In some embodiments, between MIC and FCS, padding may be required.

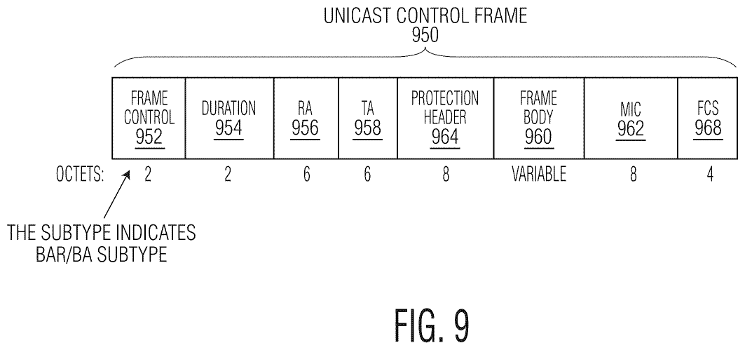

FIG. 9 illustrates a unicast control frame 950 in accordance with an embodiment of the invention. The unicast control frame 950 illustrated in FIG. 9 may be used by the wireless communications system 100 depicted in FIG. 1, the multi-link (ML) communications system 200 depicted in FIG. 2, and/or the wireless device 300 depicted in FIG. 3. In the embodiment depicted in FIG. 9, the unicast control frame 950 includes a frame control field 952 (e.g., two-octet) that may contain frame control information (e.g., the SubType indicates BA/BAR subtype), a frame duration field 954 (e.g., two-octet) that may contain frame duration information, a RA (receiver address or broadcast address) field 956 (e.g., six-octet) that may contain receiver address information, a TA (transmitter address) field 958 (e.g., six-octet) that may contain transmitter address information, a protection header field 964 (e.g., variable length) that may contain protection header information (i.e., Key ID, PN), a frame body 960 (e.g., variable length) that may contain frame body data, an MIC field 962 (e.g., eight-octet) that may contain MIC information, and a frame check sequence (FCS) field 968 (e.g., four-octet) that may contain FCS information. In some embodiments, the frame control field 952, the frame duration field 954, the RA field 956, and the TA field 958 form a MAC header.

Solution 2 for unicast frames whose control subtype does not have broadcast control frame usage:

In some embodiments, a new Control frame type “Extended Control frame” is defined.

In some embodiments, the Extended Header with variable length carries at least one Extended Control Subtype field, and one bit to indicate whether the control frame is protected. The Extended Header may carry the control frame protection information (Key ID, PN) if the bit indicates that the control frame is protected. In another variant, the Extended Header with fixed length carries Extended Control Subtype field, and one bit to indicate whether the control frame is protected. In some embodiments, if the bit in Extended Header field indicates that the control frame is protected, the Protection Header field with Key ID and PN immediately follows Extend Header field.

In some embodiments, the frame body carries the frame body of the protected unicast control frame.

In some embodiments, the MIC information is located before FCS. Between MIC and FCS, padding may be required.

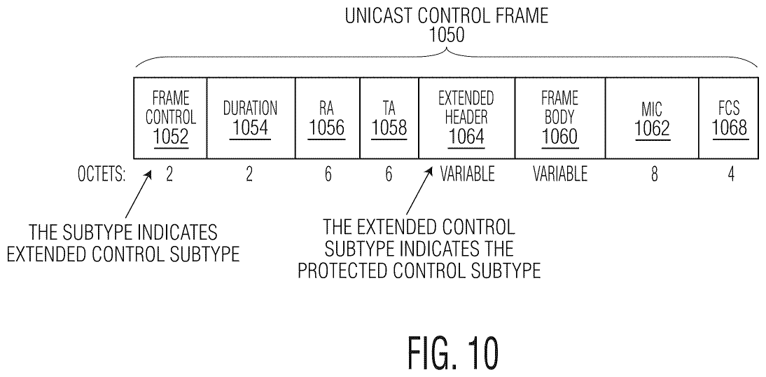

FIG. 10 illustrates a unicast control frame 1050 in accordance with an embodiment of the invention. The unicast control frame 1050 illustrated in FIG. 9 may be used by the wireless communications system 100 depicted in FIG. 1, the multi-link (ML) communications system 200 depicted in FIG. 2, and/or the wireless device 300 depicted in FIG. 3. In the embodiment depicted in FIG. 10, the unicast control frame 1050 includes a frame control field 1052 (e.g., two-octet) that may contain frame control information (e.g., the SubType indicates extended control subtype), a frame duration field 1054 (e.g., two-octet) that may contain frame duration information, a RA (receiver address or broadcast address) field 1056 (e.g., six-octet) that may contain receiver address information, a TA (transmitter address) field 1058 (e.g., six-octet) that may contain transmitter address information, an extended header field 1064 (e.g., variable length) that may contain extended header information (e.g., the Extended Control Subtype indicates the protected control subtype, Key ID, PN), a frame body 1060 (e.g., variable length) that may contain frame body data, an MIC field 1062 (e.g., eight-octet) that may contain MIC information, and a frame check sequence (FCS) field 968 (e.g., four-octet) that may contain FCS information. In some embodiments, the frame control field 1052, the frame duration field 1054, the RA field 1056, and the TA field 1058 form a MAC header.

A protected unicast frame can provide higher security than the protected broadcast frame. The protected unicast frames carried in downlink (DL) MU PPDU can replace the broadcast protected control frame. The protected broadcast frame can be carried in non-HT (High Throughput) duplicate PPDU. The non-HT duplicate PPDU can provide better Transmit opportunity (TXOP) protection for the Transmit opportunity (TXOP) since every neighbors can decode the Duration field of the frame in non-HT duplicate PPDU. The chance to perform Extended Interframe space (EIFS) recovery at the end of the TXOP is not decreased if the last PPDU of the TXOP is not non-HT (duplicate) PPDU.

In some embodiments, if/when a protected broadcast control frame is not used for the TXOP protection, e.g., not in the initial frame exchange for a TXOP, and not the last frame being transmitted in a TXOP, multiple protected unicast Control frames being carried in a DL MU PPDU are used to replace the protected broadcast control frame.

The unicast control frame is the unicast control frame other than Trigger, multi-STA BA.

Solution 1:

The protection of the unicast control frame may be explicitly indicated or implicitly indicated.

In some embodiments, the Protection Header field with Key ID and PN immediately follows MAC Header field. In another variant, Protection Header field with Key ID and PN immediately follows BAR/BA Control field respectively in protected BAR/BA frame.

In some embodiments, The frame body carries the frame body of the protected unicast control frame.

In some embodiments, the MIC is located before FCS. Between MIC and FCS, padding may be required.

Solution 2:

In some embodiments, a new Control frame type “Extended Control frame” is defined.

In some embodiments, the Extended Header with variable length carries at least one Extended Control Subtype field, and one bit to indicate whether the control frame is protected. The Extended Header may carry the control frame protection information (Key ID, PN) if the bit indicates that the control frame is protected. In another variant, the Extended Header with fixed length carries Extended Control Subtype field, and one bit to indicate whether the control frame is protected. In some embodiments, if the bit in Extended Header field indicates that the control frame is protected, the Protection Header field with Key ID and PN immediately follows Extend Header field.

In some embodiments, the frame body carries the frame body of the protected unicast control frame.

In some embodiments, the MIC is located before FCS. Between MIC and FCS, padding may be required.

Solution 1 for Trigger frame:

In some embodiments, the Frame Control or Special User Info field right after Common Info field is used to carry Key ID or Protection Indication if explicit indication is required.

In some embodiments, the Special User Info fields is located right before UHR FCS carried the PN, MIC.

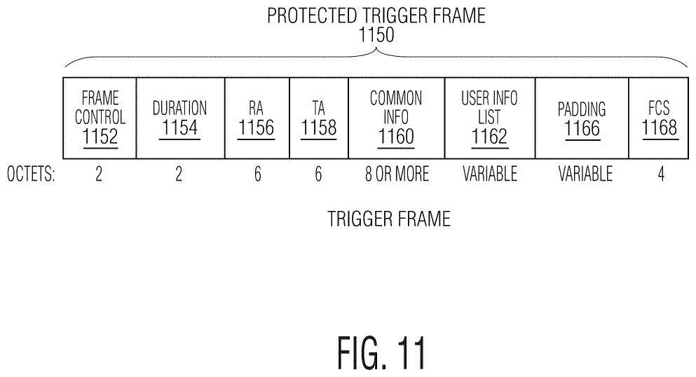

FIG. 11 illustrates a protected trigger frame format 1150 in accordance with an embodiment of the invention. The protected trigger frame format 1150 illustrated in FIG. 11 may be used by the wireless communications system 100 depicted in FIG. 1, the multi-link (ML) communications system 200 depicted in FIG. 2, and/or the wireless device 300 depicted in FIG. 3. In the embodiment depicted in FIG. 11, the protected trigger frame format 1150 includes a frame control field 1152 (e.g., two-octet) that may contain frame control information, a frame duration field 1154 (e.g., two-octet) that may contain frame duration information, a RA (receiver address or broadcast address) field 1156 (e.g., six-octet) that may contain receiver address information, a TA (transmitter address) field 1158 (e.g., six-octet) that may contain transmitter address information, a common information (info) field 1160 (e.g., eight-octet or more) that may contain common information, a user information list field 1162 (e.g., variable length) that may contain user information list (e.g., the first User Info field being the Special User Info field to carry PHY version, additional BW information of the solicited TB PPDU etc.), a padding field 1166 (e.g., variable length) that may contain padding information, and a frame check sequence (FCS) field 1168 (e.g., four-octet) that may contain FCS information. In some embodiments, the frame control field 1152, the frame duration field 1154, the RA field 1156, and the TA field 1158 form a MAC header. In some embodiments, the Frame Control or Special User Info field right after Common Info field is used to carry Key ID or Protection Indication if explicit indication is required. In some embodiments, the Special User Info fields is located right before UHR FCS carried the PN, MIC.

Solution 1 for Multi-STA BA frame:

In some embodiments, the Frame Control or BA Control field is used to carry Key ID or Protection Indication if explicit indication is required.

In some embodiments, the Special Per AID TID Info fields right before FCS field are used to carry PN, MIC. Between the special Per AID TID Info fields and FCS, padding field may exist.

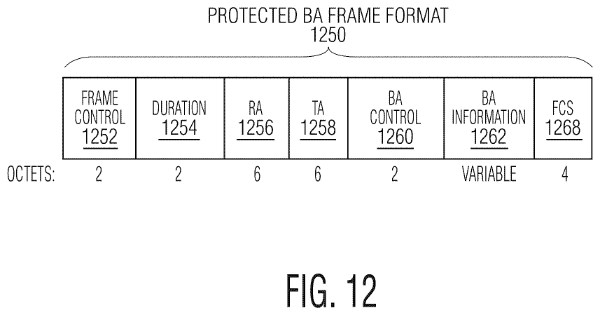

FIG. 12 illustrates a protected Block Acknowledgement (BA) frame format 1250 in accordance with an embodiment of the invention. The protected BA frame format 1250 illustrated in FIG. 12 may be used by the wireless communications system 100 depicted in FIG. 1, the multi-link (ML) communications system 200 depicted in FIG. 2, and/or the wireless device 300 depicted in FIG. 3. In the embodiment depicted in FIG. 12, the protected BA frame format 1250 includes a frame control field 1252 (e.g., two-octet) that may contain frame control information, a frame duration field 1254 (e.g., two-octet) that may contain frame duration information, a RA (receiver address or broadcast address) field 1256 (e.g., six-octet) that may contain receiver address information, a TA (transmitter address) field 1258 (e.g., six-octet) that may contain transmitter address information, a BA control field 1260 (e.g., two-octet) that may contain BA control information, a BA information field 1262 (e.g., variable length) that may contain BA information, and a frame check sequence (FCS) field 1268 (e.g., four-octet) that may contain FCS information. In some embodiments, the frame control field 1252, the frame duration field 1254, the RA field 1256, and the TA field 1258 form a MAC header. In some embodiments, the frame control field or the BA control field is used to carry Key ID or Protection Indication if explicit indication is required. In some embodiments, the Special Per AID TID Info fields right before FCS field are used to carry PN, MIC. Between the special Per AID TID Info fields and FCS, padding field may exist.

For Power Save STA Awake Notification, a Power Save (PS) Poll frame can be used as the frame for STA(s) in doze state of power save mode to notifies its awake state in power save mode, while a Quality of Service (QOS) Null frame is used as trigger frame to notifies STA's awake for Automatic Power Save Delivery (APSD)/Unscheduled Automatic Power Save Delivery (U-APSD) power save.

Solution 1:

In some embodiments, for enhanced security with MAC header protection, a protected QoS Null frame can be used to notify STA's awake state.

Solution 2:

In some embodiments, the PS Poll is protected.

Solution 3:

In some embodiments, a robust Action frame is defined for STA's awake notification.

Solution 4:

In some embodiments, the protected universal reporting control frame is used as the STA's awake notification if the STA is in doze state and notify STA's reporting information (e.g., when the STA is unavailable). With such enablement, a STA does not need to transmit protected frame for notifying its awake state and transmit another universal report frame for its unavailable time.

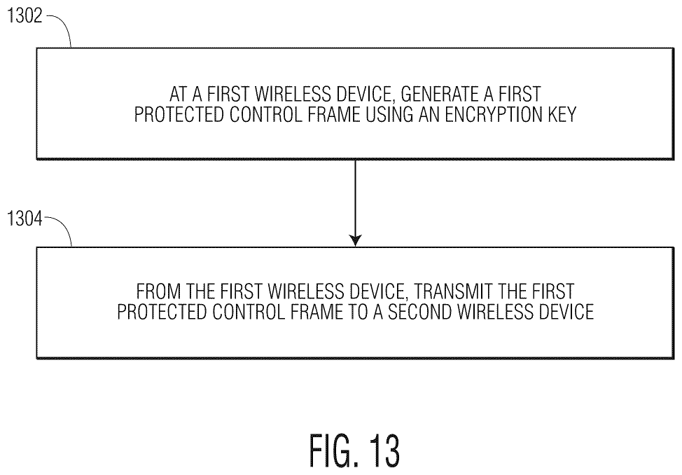

FIG. 13 is a process flow diagram of a method for wireless communications in accordance with an embodiment of the invention. At block 1302, at a first wireless device, a first protected control frame is generated using an encryption key. At block 1304, from the first wireless device, the first protected control frame is transmitted to a second wireless device. At least one of the first wireless device and the second wireless device may be the same as or similar to an embodiment of the AP 106 depicted in FIG. 1, the STA 110-1, . . . , 110-n depicted in FIG. 1, the APs 206-1, 206-2 depicted in FIG. 2, the STAs 210-1, 210-2 depicted in FIG. 2, and/or the wireless device 300 depicted in FIG. 3.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods described herein may be implemented using software instructions stored on a computer useable storage medium for execution by a computer. As an example, an embodiment of a computer program product includes a computer useable storage medium to store a computer readable program.

The computer-useable or computer-readable storage medium can be an electronic, magnetic, optical, electromagnetic, infrared, or semiconductor system (or apparatus or device). Examples of non-transitory computer-useable and computer-readable storage media include a semiconductor or solid-state memory, magnetic tape, a removable computer diskette, a random-access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Alternatively, embodiments of the invention may be implemented entirely in hardware or in an implementation containing both hardware and software elements. In embodiments which use software, the software may include but is not limited to firmware, resident software, microcode, etc.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A wireless device comprising:
a controller configured to generate a first protected control frame using an encryption key; and
a wireless transceiver configured to transmit the first protected control frame to a second wireless device.

2. The wireless device of claim 1, wherein the controller is further configured to generate a second protected control frame using the encryption key, and wherein the wireless transceiver is further configured to transmit the second protected control frame to the second wireless device.

3. The wireless device of claim 2, wherein the first protected control frame comprises a protected unicast control frame that is generated using the encryption key, and wherein the second protected control frame comprises a protected broadcast control frame that is generated using the encryption key.

4. The wireless device of claim 1, wherein the encryption key comprises a pair-wise key or a group key, and wherein the first protected control frame is decrypted by the second wireless device.

5. The wireless device of claim 4, wherein the pair-wise key comprises a control frame peer transient key (CPTK).

6. The wireless device of claim 4, wherein the group key comprises a control frame group temporal key (CGTK).

7. The wireless device of claim 3, wherein a trigger frame being the first or second protected control frame comprises a protected trigger frame, and wherein the protected trigger frame comprises a trigger type value that indicates the protected trigger frame.

8. The wireless device of claim 7, wherein packet number (PN) information and key identification (ID) information are carried right after a Media Access Control (MAC) header of the protected trigger frame.

9. The wireless device of claim 3, wherein a multi-station (multi-STA) block acknowledgement (BA) frame being the first or second protected control frame comprises a protected multi-STA BA frame, and wherein the protected multi-STA BA frame comprises a BA type value that indicates the protected multi-STA BA frame.

10. The wireless device of claim 9, wherein key identification (ID) information and packet number (PN) information are carried right after a Media Access Control (MAC) header of the protected multi-STA BA frame.

11. The wireless device of claim 3, wherein the first protected control frame comprises a protected extended control frame, and wherein the protected extended control frame comprises an extended header that carries at least one extended control subtype field.

12. The wireless device of claim 1, wherein the controller is further configured to generate a second protected control frame using a key for integrity checking, and wherein the wireless transceiver is further configured to transmit the second protected control frame to the second wireless device.

13. The wireless device of claim 12, wherein the first protected control frame comprises a protected unicast control frame that is generated using the encryption key, and wherein the second protected control frame comprises a protected broadcast control frame that is generated using the key for integrity checking.

14. The wireless device of claim 12, wherein the first protected control frame is decrypted by the second wireless device, and wherein the second protected control frame is integrity checked by the second wireless device.

15. The wireless device of claim 12, wherein a protected broadcast Trigger frame or multi-station (multi-STA) block acknowledgement (BA) frame is replaced by a protected unicast Trigger frame or Multi-STA BA frame, respectively, if the protected broadcast Trigger frame or multi-STA BA) frame is not for improving Transmit opportunity (TXOP) protection and not for a last frame of the TXOP.

16. The wireless device of claim 1, wherein the wireless device comprises a wireless multi-link device (MLD), and wherein the second wireless device comprises a second wireless MLD.

17. The wireless device of claim 1, wherein the wireless device is compatible with an Institute of Electrical and Electronics Engineers (IEEE) 802.11 protocol.

18. The wireless device of claim 1, wherein the wireless device comprises a wireless access point (AP) or a non-AP station (STA).

19. A wireless access point (AP) compatible with an Institute of Electrical and Electronics Engineers (IEEE) 802.11 protocol, the wireless AP comprising:
a controller configured to generate a first protected control frame using an encryption key; and
a wireless transceiver configured to transmit the first protected control frame to a second wireless device.

20. A method for wireless communications, the method comprising:
at a first wireless device, generating a first protected control frame using an encryption key; and
from the first wireless device, transmitting the first protected control frame to a second wireless device.
